(19) United States
(12) Patent Application Publication
(10) Pub. No.: US 2021/0263234 A1
(43) Pub. Date: Aug. 26, 2021

(54) OPTICAL RECEPTACLE AND OPTICAL CONNECTOR MODULE USING THE SAME

(71) Applicant: Chung-Ming TSENG, Myau-Li County (TW)

(72) Inventor: Chung-Ming TSENG, Myau-Li County (TW)

(21) Appl. No.: 17/175,668

(22) Filed: Feb. 14, 2021

(30) Foreign Application Priority Data
Feb. 20, 2020 (TW) 109105559

(51) Int. Cl. G02B 6/38

(52) U.S. Cl. CPC G02B 6/3869

(57) ABSTRACT

The present invention provides an optical receptacle comprising a receptacle body having at least one coupling structure formed at a first side thereof. Each of the coupling structure comprises a first connecting structure having a terminal coupling portion and a pair of positioning grooves respectively formed at the two opposite sides of the terminal coupling portion. Each positioning groove further comprises an insertion groove and a fixing groove formed at a side of the insertion groove. Alternatively, in another embodiment, an optical connector module has the optical receptacle and a first connector. The first connector has a first coupling portion and a first positioning structure, wherein the first coupling portion is inserted into the insertion groove along an inserting direction, and is moved into the fixing groove through rotation whereby the first connector is locked in the receptacle body.

### CROSS-REFERENCE TO RELATED APPLICATION

This application claims the benefit of Taiwan Patent Application No. 109105559, filed on Feb. 20, 2020, in the Taiwan Intellectual Property Office of the R.O.C, the disclosure of which is incorporated herein in its entirety by reference.

### FIELD OF INVENTION

The present invention relates to an optical receptacle. In particular, it relates to an optical receptacle suitable for combining different types of optical connectors and an optical connector module using the same.

### BACKGROUND OF THE INVENTION

Optical fibers have been widely used as signal transmission media in recent years due to the advantages of high frequency bandwidth and low loss. The use of optical fiber has already had a major revolutionary impact in the communications industry. Nowadays, 100G optical module communication is not enough, and the future will be expected to move towards the era of 400G optical module communications.

In the field of 400G optical communications, there are also many designs for the packaging design of optical fiber modules, one of which is called Quad Small Form Factor Pluggable-Double Density (QSFF-DD). The specification, with a downward compatible design, has attracted the attention of many large manufacturers, and has launched corresponding specifications of optical communication module products.

For example, in the prior art, it disclosed an optical connector module. In order to solve the space problem during assembly, an optical connector that is compatible with two different forms is provided, such as a micro connector and an LC connector. The micro connector is fixed on the first side of the optical receptacle by rotating and fixing, and the LC connector is fixed on the second side of the optical receptacle.

The above information disclosed in this section is only for enhancement of understanding of the background of the described technology and therefore it may contain information that does not form the prior art that is already known to a person of ordinary skill in the art.

### SUMMARY OF THE INVENTION

The invention provides an optical receptacle and an optical connector module using the same. A rotating lock mechanism is arranged in the optical receptacle to allow an optical connector to be coupled with the optical receptacle in a limited space and achieve a fixing effect.

The present invention provides an optical receptacle and an optical connector module using the same. The receptacle body may be used for coupling with different types of connectors, such as a rotating-fixed type connector or a plug-in type connector, to provide users with different insertion methods and increase the flexibility of application.

In one embodiment of the present invention, the present invention provides an optical receptacle, comprising: a receptacle body, a first side of the receptacle body having at least one coupling portion, each the coupling portion having a first connecting structure, further comprising: a terminal coupling portion; and a pair of positioning grooves, formed at two sides of the terminal coupling portion, the each positioning groove having an insertion groove and a fixing groove disposed at a side of the insertion groove.

In one embodiment of the present invention, the present invention also provides an optical connector module, comprising: a first connector, having a first terminal portion and a first positioning structure; and an optical receptacle, having a receptacle body, a first side of the receptacle body having at least one coupling portion, the each coupling portion having a first connecting structure, further comprising: a terminal coupling portion; and a pair of positioning grooves, formed at two sides of the terminal coupling portion, the each positioning groove having an insertion groove and a fixing groove disposed at a side of the insertion groove, wherein after the first positioning structure is inserted into the insertion groove along an insertion direction, the first positioning structure is embedded into the fixing groove by rotation.

Many of the attendant features and advantages of the present invention will become better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is a three-dimensional diagram of an embodiment of the optical receptacle in the present invention.

FIGS. 2A and 2B are schematic side views of the receptacle body shown in FIG. 1 from the visual angle of second side B.

FIGS. 3A and 3B are schematic diagrams of different embodiments of the optical receptacle in the present invention.

FIG. 3C is a schematic diagram of the assembly method of the optical receptacle in the present invention.

FIG. 4A is a three-dimensional diagram of an embodiment of the optical connector in the present invention.

FIG. 4B is an exploded schematic diagram of the optical connector module in the present invention.

FIG. 4C is a three-dimensional diagram of another embodiment of the optical connector in the present invention.

FIGS. 5A to 5D are schematic diagrams of assembling the first connector and the first connecting structure in the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The following descriptions are provided to elucidate an optical receptacle and an optical connector module using the same to aid it of skilled in the art in practicing this invention. These embodiments are merely exemplary embodiments and in no way to be considered to limit the scope of the invention in any manner.

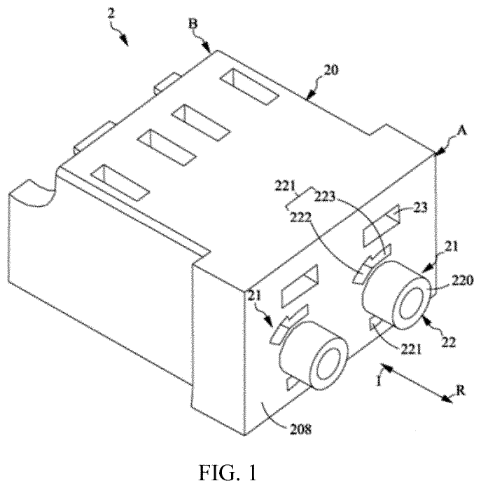

Please refer to FIG. 1, which is a three-dimensional diagram of an embodiment of the optical receptacle in the present invention. The optical receptacle 2 includes a receptacle body 20, a first side A of which has at least one coupling portion 21, and each coupling portion 21 has a first connecting structure 22. In this embodiment, the first connecting structure 22 has a terminal coupling portion 220 and a pair of positioning grooves 221. An end of the terminal coupling portion 220 protrudes from the surface 208 of the first side A of the receptacle body 20, and another end of the terminal coupling portion 220 extends toward the second side B of the receptacle body 20 and is formed inside the receptacle body 20. The positioning grooves 221 are respectively formed on both sides of the terminal coupling portion 220, and each positioning groove 221 further has an insertion groove 222 and a fixing groove 223 disposed on a side of the insertion groove 222.

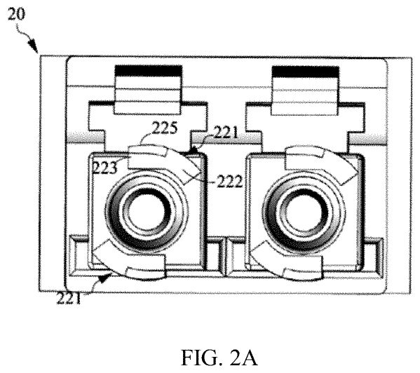

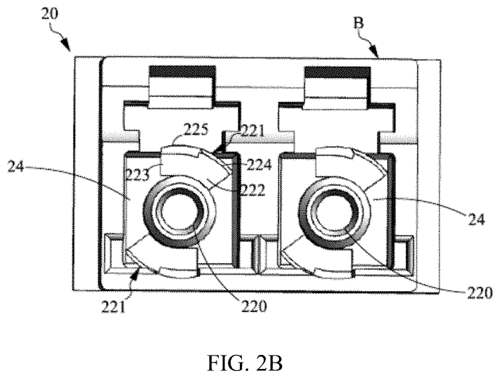

Please refer to FIGS. 2A and 2B, which are schematic side views of the receptacle body shown in FIG. 1 from the visual angle of second side B. In this embodiment, the fixing groove 223 has a stopper 225, which restrains the connector to move in the drawing direction (R), which is opposite to the insertion direction (I), after the connector is inserted. The operation method would be described later. In another embodiment, as shown in FIG. 2B, the insertion groove 222 has a restraining member 224 for restraining the rotation of the connector after the connector is coupled and fixed to the receptacle body 20. The detailed operation method would also be described later.

Returning to FIG. 1, the coupling portion 21 further has a second connecting structure 23 formed on a side of the first connecting structure 22 to allow a fixing member of another type of connector to be inserted into the second connecting structure 23 to generate the effect of positioning and fixing the connector, the detailed operation method would be described later. Through the design of the coupling portion 21 of the receptacle body 20 in FIG. 1, the receptacle body 20 allows different types of connector for coupling by the same coupling structure design. The first type of connector is coupled to the receptacle body 20 along the insertion direction (I), and then is fixed to the receptacle body 20 through rotation. The second type of connector does not rotate. It is directly coupled to the receptacle body 20 along the insertion direction (I), and then coupled to the second connecting structure 23 through the fixing member on the connector body to generate the fixing effect.

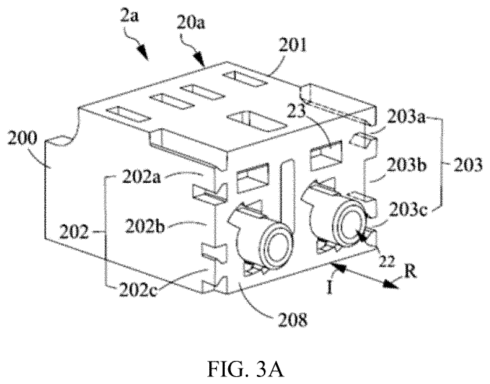

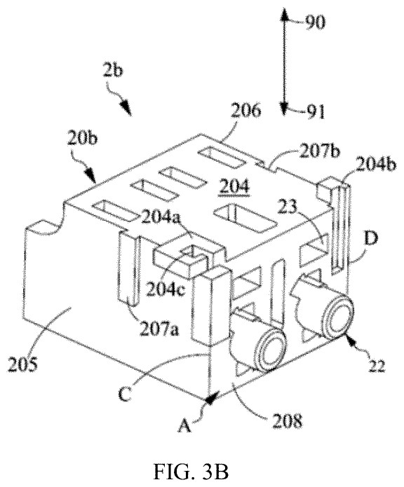

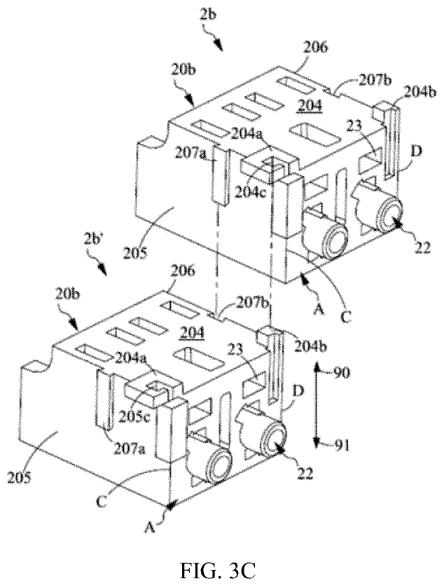

Please refer to FIGS. 3A and 3B, which are schematic diagrams of different embodiments of the optical receptacle in the present invention. In the embodiment of FIG. 3A, the receptacle body 20a of the optical receptacle 2a has a first side wall 200 and a second side wall 201 opposite to the first side wall 200. The first side wall 200 has a first series connecting structure 202. A second series connecting structure 203 is disposed on the second side wall 201, and the first series connecting structure 202 is connected to the second series connecting structure 203 of another optical receptacle to form a row of optical receptacle in series. In this embodiment, through the first series connecting structure 202 and the second series connecting structure 203, the first side wall 200 of one receptacle body 20 is attached to the second side wall 201 of another receptacle body to combine. In this embodiment, the first series connecting structure 202 has a plurality of protruding connecting structures 202a˜202c, and the second series connecting structure 203 has a corresponding concave structure 203a˜203c that match with the protruding connecting structures 202a˜202c. Therefore, when combined, the connecting structure 202a is inserted into the concave structure 203a, the connecting structure 202b is inserted into the groove structure 203b, and the connecting structure 202c is inserted into the groove structure 203c. It should be noted that the number of protruding connecting structures and concave structures is determined according to requirements, and it's not limited thereto. In another embodiment, the first series connecting structure 202 may be a concave structure, and the second series connecting structure 203 may also be a protruding connecting structure.

As shown in FIG. 3B, in this embodiment, the design of series connecting structure of the optical receptacle 2b is that the receptacle body 20b has a first surface 204, which is the upper surface of the receptacle body 20b in this embodiment. A first coupling side C on the first surface 204 has a third series connecting structure 204a, the first surface 204 and a second coupling side D opposite to the first coupling side C have a fourth series connecting structure 204b, wherein the third series connecting structure 204a is connected to the fourth series connecting structure 204b of another optical receptacle. In this embodiment, the third series connecting structure 204a is a block structure with a through hole 204c in the middle, and the fourth series connecting structure 204b is a protruding block that may be matched with the through hole 204c. In addition, in order to enhance the series connecting and fixing effect of the optical receptacle 2b, a fifth series connecting structure 207a and a sixth series connecting structure 207b are further respectively disposed on the first side wall 205 and the second side wall 206 opposite to the first side wall 205 of the receptacle body 20b; wherein the fifth series connecting structure 207a is connected with the sixth series connecting structure 207b of another optical receptacle. In this embodiment, the fifth series connecting structure 207a is a protruding sliding column, and the sixth series connecting structure 207b is a sliding groove that is matched with the protruding sliding column.

As shown in FIG. 3C, during installation, the first coupling side C of the optical receptacle 2b is close to the second coupling side D of another optical receptacle 2b′, and the optical receptacle 2b′ approaches the optical receptacle 2b in the direction 90, so that the fourth series connecting structure 204b passes through the through hole 204c of the third series connecting structure 204a, and the sixth series connecting structure 207b is slidably connected to the fifth series connecting structure 207a to generate a double fixing effect. It should be noted that the structure of the third series connecting structure 204a and the fourth series connecting structure 204b may be exchanged, and the structure of the fifth series connecting structure 207a and the sixth series connecting structure 207b may also be exchanged. It's not limited to the structure shown in FIG. 3B.

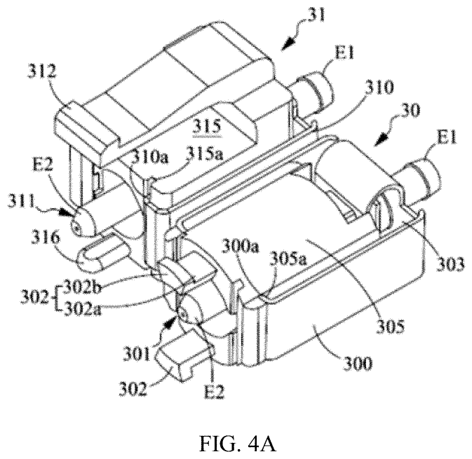

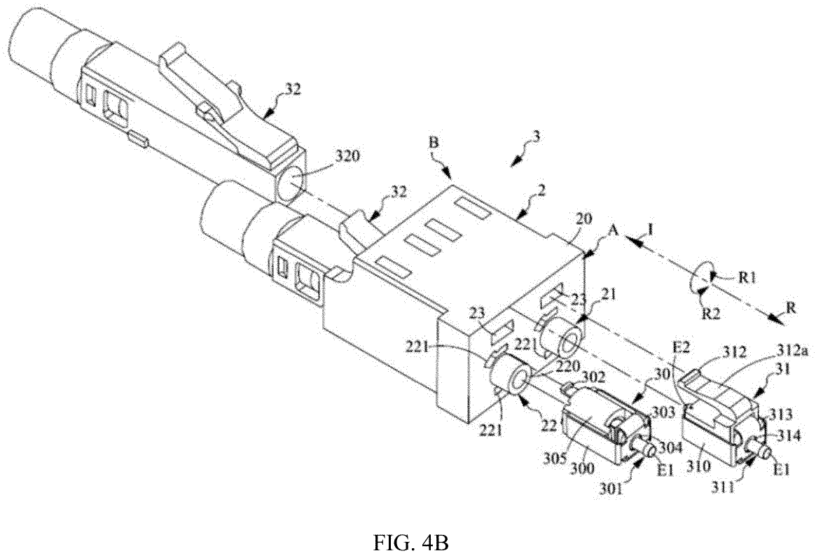

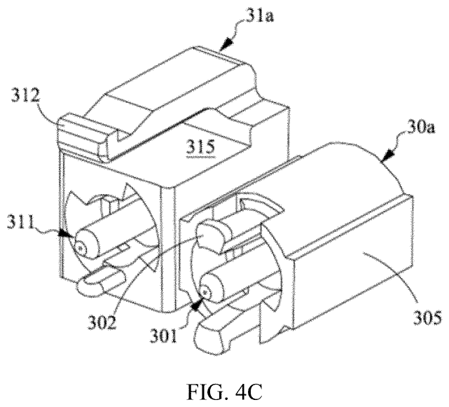

Please refer to FIGS. 4A and 4B, in which FIG. 4A is a three-dimensional diagram of an embodiment of the optical connector in the present invention, and FIG. 4B is an exploded schematic diagram of the optical connector module in the present invention. In this embodiment, the optical connector module 3 includes an optical receptacle 2 and first to third connectors 30-32. The optical receptacle is able to be combined with the aforementioned different types of receptacles. In this embodiment, the optical receptacle 2 shown in FIGS. 1 and 2B is used. The first connector 30 is a micro connector, but it is not limited thereto. The first connector 30 has a first supporting frame 300 and a rotating base 305 in this embodiment. The first supporting frame 300 has a first recess 303 and a first through hole 304, which allows the first end E1 of the first terminal portion 301 to pass through. The rotating base 305 is disposed in the first recess 303 and connected to the first supporting frame 300. In this embodiment, two sides of the rotating base 305 have opening slots 305a, and an end of the first supporting frame 300 has an embedding portion 300a used for embedding into the corresponding opening slot 305a, so that the rotating base 305 may be fixed with the first supporting frame 300.

The first terminal portion 301 is disposed in the rotating base 305, which has a first positioning structure 302 corresponding to the surface of the first connecting structure 22. In this embodiment, the first positioning structures 302 are respectively formed on two sides of the second end E2 of the first terminal portion 301 and correspond to the positioning groove 221. The first positioning structure 302 of this embodiment has a cantilever 302a protruding from an end surface of the rotating base 305, and a block structure 302b disposed at an end of the cantilever 302a. When the first connector 30 is coupled to the first connecting structure 22, the second end E2 of the first terminal portion 301 is coupled to the terminal coupling portion 220.

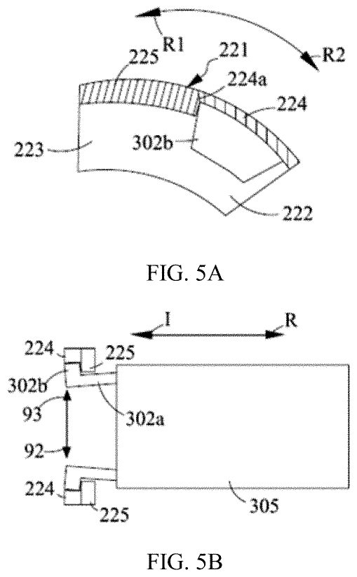

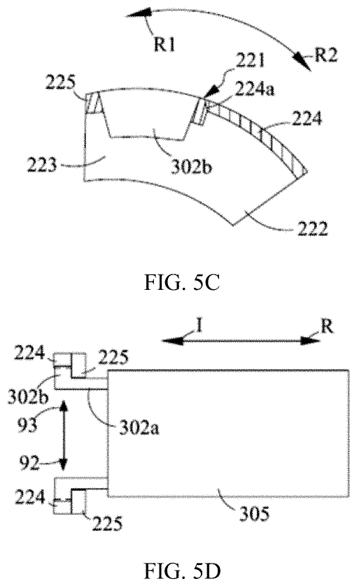

Please refer to FIGS. 5A to 5D, which are schematic diagrams of assembling the first connector and the first connecting structure in the present invention. The positioning groove in this embodiment is the same as the positioning groove shown in FIG. 2B. When assembled, as shown in FIGS. 5A and 5B, the first positioning structure 302 of the first connector 30 passes through the insertion groove 222 of the corresponding positioning groove 221 along the insertion direction (I). Because the restraining member 224 is protruded from the wall edge of the insertion groove 222, the block structure 302b on the first positioning structure 302 is pressed by the restraining member 224 to generate a force in the direction of the axis of the rotating base 305. Since the cantilever 302a has a certain length, the force makes the cantilever deformed and a flexible restoring force is accumulated, so that the block structure 302b generates displacement movement in the axial direction 92 of the rotating base 305.

At this time, the rotating force in the rotating direction R1 is applied to the rotating base 305 so that the rotating base 305 rotates toward the fixing groove 223. As shown in FIGS. 5C and 5D, as the rotating base 305 rotates, the block structure 302b would escape the compression of the restraining member 224 and enter into the fixing groove 223. Since there is no restraining member 224 in the fixing groove 223, the block structure 302b is no longer compressed by the restraining member 224, and the accumulated flexible restoring force is released without restraint, so that the cantilever 302a rebounds to the original position in another direction 93. In addition, a stopper 225 protrudes from the wall edge of the fixing groove 223 to block the block structure 302b in the fixing groove 223, so that when the first connector 30 is located in the fixing groove 223, it would not be pulled out by the force from the drawing direction (R). In addition, it should be noted that since a thickness 224a is protruded from the restraining member 224 in the insertion groove 222 adjacent to the fixing groove 223. During operation, the thickness 224a of the restraining member 224 may also generate the restraining effect on the first connector 30 in the rotation direction R2.

When the first connector 30 is taken away from the receptacle body 20, as long as a rotation force opposite to the rotation direction R2 is applied to the rotation base 305, the rotation force allows the block structure 302b to overcome the protruding thickness 224a of the restraining member 224, and the block structure 302b rotates from the fixing groove 223 to the insertion groove 222 under the rotation force. At this time, the user may apply a force in the drawing direction (R) to pull the first connector 30 away from the receptacle body 20.

Please refer to FIGS. 4A and 4B, the receptacle body 20 in this embodiment allows another type of second connector 31 to be coupled to the receptacle body 20 without changing the structure of the receptacle body 20. In this embodiment, the difference from the first connector 30 is that the second connector 31 moves linearly along the insertion direction (I) to couple with the receptacle body 20, and also moves linearly along the drawing direction (R) to detach from the receptacle body. The second connector 31 has a second terminal portion 311, a second supporting frame 310 and a seat body 315. The second supporting frame 310 has a second recess 313 and a second through hole 314, which allows the first end E1 of the second terminal portion 311 to pass through.

The seat body 315 is disposed into the second recess 313 and connected to the second supporting frame 310. In this embodiment, the seat body 315 has an assembly groove 315a for combining with the embedding portion 310a at the end of the second supporting frame 310, so that the seat body 315 may be fixed on the second supporting frame 310. A second terminal portion 311 is disposed into the seat body 315. In addition, a fixing member 312 is formed on the surface of the seat body 315. When the second end E2 of the second terminal portion 311 is coupled to the terminal coupling portion 220 of the first connecting structure 22 of the corresponding coupling portion 21, the fixing member 312 is embedded into the corresponding second connecting structure 23. In order to enhance the fixing effect of the second connector 31 and the receptacle body 20, an end of the seat body 315 of the second connector 31 further has a second positioning structure 316. When the second connector 31 is coupled to the coupling portion 21, the second positioning structure 316 is coupled to one of the positioning grooves 221. In this embodiment, the second positioning structure 316 is coupled to the positioning groove 221 under the terminal coupling portion 220. Since the fixing member 312 also has the cantilever 312a, when the second connector 31 is to be taken away from the receptacle body 20, the cantilever 312a is pressed, so that the fixing member 312 is disconnected from the second connecting structure 23, and the second connector 31 may be taken away from the receptacle body 20. It should be noted that the first supporting frame 300 and the second supporting frame 310 of the aforementioned first connector 30 and the second connector 31 are not necessary components. In another embodiment, please refer to FIG. 4C. The first connector 30a and the second connector 31a do not have the first supporting frame 300 and the second supporting frame 310, respectively.

Returning to FIG. 4B and FIG. 2B, the aforementioned first connector 30 and second connector 31 are coupled to the coupling portion 21 of the first side A of the receptacle body 20, the second side B of the receptacle body 20 has insertion hole 24 corresponding to the coupling portion 21, and a terminal coupling portion 220 corresponding to the first connecting structure 22 is disposed into the insertion hole 24. In this embodiment, the terminal coupling portion 220 extends from the first side A of the receptacle body 20 to the inside of the receptacle body 20. Each insertion hole 24 allows a third connector 32 to be inserted into the receptacle body 20. Each third connector 32 has a through hole 320 that is coupled to the terminal coupling portion 220 in the receptacle body 20, so that the third connector 32 is electrically connected to the first connector 30 or the second connector 31. In one embodiment, an LC connector may be considered as the third connector, but it is not a limited herein.

In summary, the optical receptacle of the present invention is able to be compatible with different types of connectors through a single connection interface, such as a rotating-fixed type connector or a plug-in type connector. For the connector that cannot be connected to the receptacle body by rotation, the plug-in type connector can be used. Conversely, for the situation where the plug-in type connector cannot be used, the rotating-fixed type connector can be used, so that the optical receptacle of the present invention is more flexible in coupling to different type of connectors.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations or modifications to the disclosed embodiments without departing from the spirit or scope of this invention.

What is claimed is:

1. An optical receptacle, comprising:
a receptacle body, a first side of the receptacle body having at least one coupling portion, the each coupling portion having a first connecting structure, comprising:
a terminal coupling portion; and
a pair of positioning grooves, formed at two sides of the terminal coupling portion, the each positioning groove having an insertion groove and a fixing groove disposed at a side of the insertion groove.

2. The optical receptacle of claim 1, wherein the insertion groove has a first stopper for restraining a rotation of a first connector.

3. The optical receptacle of claim 1, wherein the fixing groove has a second stopper for restraining a first connector to move in a drawing direction opposite to an insertion direction.

4. The optical receptacle of claim 1, wherein after a first positioning structure of a first connector to is inserted into the insertion groove along an insertion direction, the first positioning structure is embedded into the fixing groove by rotation.

5. The optical receptacle of claim 1, wherein the coupling portion has a second connecting structure formed at a side of the first connecting structure, and a fixing member of a second connector is inserted into the second connecting structure.

6. The optical receptacle of claim 1, wherein the receptacle body has a first side wall and a second side wall opposite to the first side wall, the first side wall has a first series connecting structure, the second side wall has a second series connecting structure, and the first series connecting structure is connected to the second series connecting structure of another optical receptacle.

7. The optical receptacle of claim 1, wherein the receptacle body has a first surface, a first coupling side disposed on the first surface has a third series connecting structure, the first surface and a second coupling side opposite to the first coupling side have a fourth series connecting structure, and the third series connecting structure is connected to the fourth series connecting structure of another optical receptacle.

8. The optical receptacle of claim 7, wherein the receptacle body has a first side wall and a second side wall opposite to the first side wall, the first side wall has a fifth series connecting structure, the second side wall has a sixth series connecting structure, and the fifth series connecting structure is connected to the sixth series connecting structure of the another optical receptacle.

9. An optical connector module, comprising:
a first connector, having a first terminal portion and a first positioning structure; and
an optical receptacle, having a receptacle body, a first side of the receptacle body having at least one coupling portion, the each coupling portion having a first connecting structure, comprising:
a terminal coupling portion; and
a pair of positioning grooves, formed at two sides of the terminal coupling portion, the each positioning groove having an insertion groove and a fixing groove disposed at a side of the insertion groove,
wherein after the first positioning structure is inserted into the insertion groove along an insertion direction, the first positioning structure is embedded into the fixing groove by rotation.

10. The optical connector module of claim 9, wherein the first connector comprises:
a first supporting frame, having a first recess and a first through hole, which allows a first end of the first terminal portion to pass through; and
a rotating base, disposed in the first recess and connected to the first supporting frame, the first terminal portion disposed in the rotating base, which has a first positioning structure corresponding to the first connecting structure,
wherein when the first connector is coupled to the first connecting structure, a second end of the first terminal portion is coupled to the terminal coupling portion.

11. The optical connector module of claim 10, wherein the insertion groove has a first stopper for restraining a rotation of a first connector.

12. The optical connector module of claim 10, wherein the fixing groove has a second stopper for restraining a first connector to move in a drawing direction opposite to an insertion direction.

13. The optical connector module of claim 10, wherein the coupling portion has a second connecting structure formed at a side of the first connecting structure, and a fixing member of a second connector is coupled to the second connecting structure to fix the second connector into the receptacle body.

14. The optical connector module of claim 13, wherein the second connector comprises:
a second terminal portion;
a second supporting frame, having a second recess and a second through hole, which allows a first end of the second terminal portion to pass through; and
a seat body, disposed into the second recess and connected to the second supporting frame, the second terminal portion disposed into the seat body, and the fixing member formed on the seat body,
wherein when the second connector is coupled to one of the coupling portions, a second end of the second terminal portion is coupled to the terminal coupling portion of the coupling portion of the corresponding second connector.

15. The optical connector module of claim 14, wherein the seat body of the second connector has a second positioning structure; when the second connector is coupled to the coupling portion, the second positioning structure is coupled to one of the positioning grooves.

16. The optical connector module of claim 10, wherein the receptacle body has a first side wall and a second side wall opposite to the first side wall, the first side wall has a first series connecting structure, the second side wall has a second series connecting structure, and the first series connecting structure is connected to the second series connecting structure of another optical receptacle.

17. The optical connector module of claim 10, wherein the receptacle body has a first surface, a first coupling side disposed on the first surface has a third series connecting structure, the first surface and a second coupling side opposite to the first coupling side have a fourth series connecting structure, and the third series connecting structure is connected to the fourth series connecting structure of another optical receptacle.

18. The optical connector module of claim 17, wherein the receptacle body has a first side wall and a second side wall opposite to the first side wall, the first side wall has a fifth series connecting structure, the second side wall has a sixth series connecting structure, and the fifth series connecting structure is connected to the sixth series connecting structure of the another optical receptacle.
